(19) United States
(12) Patent Application Publication
(10) Pub. No.: US 2011/0216828 A1
(43) Pub. Date: Sep. 8, 2011

(54) I-FRAME DE-FLICKERING FOR GOP-PARALLEL MULTI-THREAD VICEO ENCODING

(76) Inventor: Hua Yang, Princeton, NJ (US)

(21) Appl. No.: 12/998,643

(22) PCT Filed: Nov. 10, 2009
(86) PCT No.: PCT/US09/06056

§ 371 Date: May 12, 2011

Related U.S. Application Data
(62) Division of application No. 61/199,028, filed on Nov. 12, 2008.

(51) Int. Cl. H04N 7/32

(52) U.S. Cl. 375/240.12; 375/E07.243

(57) ABSTRACT

A method of encoding video is presented in which multiple groups of pictures (GOPs) are formed and encoded in parallel threads. Each encoded GOP has an initial I-frame followed by a series of P-frames. Each I-frame is deflicker coded with a first derived no flicker reference from the nearest coded frame of a preceding GOP and, the last P-frame in the series of the preceding GOP is deflicker coded with a second derived no flicker reference from the deflicker coded I-frame.

### FIELD OF THE INVENTION

The invention is related to video encoding and more particularly to I-frame flicker artifact removal where video is coded into Groups-of-Pictures (GOPs).

### BACKGROUND OF THE INVENTION

When playing out a GOP coded video, annoying pulsing, or the so called flickering artifact will usually be seen at the periodic I-frames for the GOPs in the same scene. Especially for low or medium bit rate video coding, this I-frame flickering is very obviously seen, which greatly compromises the overall perceptual quality of the coded video.

Original video signals have naturally smooth optical flows. However, after poor quality video encoding, the natural optical flow will be distorted in the coded video signals. The resultant temporal inconsistency/incoherence across coded frames will then be perceived as the flickering artifact. In practice, flickering is more often perceived at static or low motion areas/portions of a coded video. For example, several consecutive frames may share the same static background. Hence, all the collocated pixels in the static background across these frames bear the same or similar pixel values in the original input video. However, in video encoding, the collocated pixels may be predicted from different reference pixels in different frames, and hence after quantizing the residue, yield different reconstruction values. Visually, the increased inter-frame differences across these frames will be perceived as flickering during coded video playing out.

As such, a flickering artifact is more intensive for low or medium bit rate coding due to coarse quantization. Also, it is more obviously observed on I-frames than on P or B-frames. This is mainly because for the same static areas, prediction residue resultant from inter-frame prediction in P- or B-frames is usually much smaller than that resultant from intra-frame prediction or no-prediction in I-frames. Thus, with coarse quantization, the reconstructed static areas in an I-frame demonstrate more noticeable difference from the collocated areas in previous P- or B-frames, and hence, more noticeable flickering artifact. Therefore, how to eliminate I-frame flickering is a critical issue that greatly affects the overall perceptual video coding quality.

Most of the existing encoder-based I-frame deflicker schemes are designed for the GOP-sequential single-thread video coding case, where when coding an I-frame, its immediate previous frame has already been coded. Hence, one can readily use the reconstructed previous frame to derive the no flicker reference for the current frame, which can then be used for deflickering of the current I-frame.

FIG. 1 illustrates a commonly used two-pass I-frame deflicker approach for GOP-sequential single-thread coding. In this case, P_last 4 has always been coded before coding I_next 8, and hence, can always be exploited to derive no flicker reference of I_next 8 for its deflickering. Because P_last 4 immediately precedes I_next 8, it is more often than not that the two frames are of high correlation, and hence, the derived no flicker reference is generally good for deflickering.

Using multiple encoding threads, instead of one single thread, is a commonly used effective parallelization strategy to greatly accelerate the computationally intensive video coding process in real-time video coding systems. While multi-threads may be exploited in many various ways in practice, one straightforward, and hence, commonly adopted approach is to let multiple threads encode multiple GOPs respectively and simultaneously. This is the scenario for GOP-parallel coding. Note that throughout this description, the terms “GOP-parallel” and “multi-thread” will be used exchangeably, and “GOP-sequential” and “single-thread” will likewise be used exchangeably.

Multi-thread coding renders I-frame flicker removal a much more challenging task than that in the case of GOP-sequential single-thread coding. In single-thread coding, when coding an I-frame, the frame immediately before it has already been coded, whose reconstruction can be readily exploited to derive a good no flicker reference for deflicker coding of the current I-frame (for example, via exhaustive or simplified P-frame coding for the first coding pass). However, in the GOP-parallel multi-thread coding case, it is most likely that when coding an I-frame, its immediate previous frame might not be coded yet, as the two frames may belong to two different GOPs which are coded by two different coding threads. In this case, one solution is to use the coded frame in the previous GOP that is closest to the current I-frame to generate its no flicker reference for deflickering. However, if that frame is too far away from the current frame, such that the two frames are not well correlated, a good no flicker reference might not be derived from that frame, and hence, adequate flicker removal might not be achieved.

Generally, I-frame flickering as well as any other coding artifact can be removed or reduced either by properly modifying the encoding process or by adding some effective post-processing at the decoder. However, post-processing based de-flickering is often not a good solution in practical video coding applications, as a coded video bitstream may be decoded by decoders/players from a variety of different manufacturers, some of which may not employ the specific post-processing technique (e.g. in order to reduce the product cost).

### SUMMARY

A method of encoding video is presented in which multiple groups of pictures (GOPs) are formed and encoded in parallel threads. Each encoded GOP has an initial I-frame followed by a series of P-frames. Each I-frame is deflicker coded with a first derived no flicker reference from the nearest coded frame of a preceding GOP and, the last P-frame in the series of the preceding GOP is deflicker coded with a second derived no flicker reference from the deflicker coded I-frame. Small quantization parameters (QPs) can be employed in coding the I-frame to closely approach the first no flicker reference. Medium QPs can be employed in coding the last P-frame. In the method, the first derived no flicker reference can be generated by a one pass simplified P-frame coding. The simplified p-frame coding can comprise the step of applying a larger motion search range for a low correlation between the I-frame and the nearest coded frame in the preceding GOP. The simplified p-frame coding can also comprise the step of applying a smaller motion search range for a high correlation between the I-frame and the nearest coded frame in the preceding GOP or comprise forgoing skip mode checking in mode selection, wherein the correlation can be determined by sum inter-frame complexity or can be determined by sum inter-frame complexity. The simplified p-frame coding could also comprise the step of checking only P16×16 mode, using smaller motion search range, and coding distortion matching between the current frame MB and the prediction reference MB, and modifying RD cost in RDO-MS, thereby preventing or discouraging skip and intra modes.

### BRIEF DESCRIPTION OF THE DRAWINGS

The invention will now be described by way of example with reference to the accompanying figures of which:

FIG. 1 is a schematic diagram of an existing two-pass I-frame deflicker approach for GOP-sequential single thread coding;

FIG. 2 is a schematic diagram of an I-frame deflicker solution for GOP-parallel multi-thread coding according to the invention;

FIG. 3 is a graph of resultant deflicker performance of the multi-thread I-frame deflicker solution of FIG. 2;

FIG. 4 is a block diagram of the multi-thread I-frame deflicker framework;

FIG. 5 is a block diagram showing proper reference frame loading from the deflicker_buffer of FIG. 4;

FIG. 6 is a block diagram showing buffering current frame coding results into the deficker_buffer of FIG. 4;

FIG. 7 is a block diagram showing deflicker coding of an I_next MB; and,

FIG. 8 is a block diagram showing deflicker coding of a P_last MB.

### DETAILED DESCRIPTION OF THE EMBODIMENTS

In the GOP-parallel multi-thread video coding scenario, a GOP starts with an IDR frame and ends with a P-frame. Note that inter-GOP prediction, i.e. prediction across GOP boundaries, although rendering more or less improved coding efficiency, is difficult to be supported in this GOP-parallel multi-thread coding architecture. Therefore, the above assumption generally always holds true. Without loss of generality, it is assumed that each GOP only has one I-frame, which is also its 1st frame.

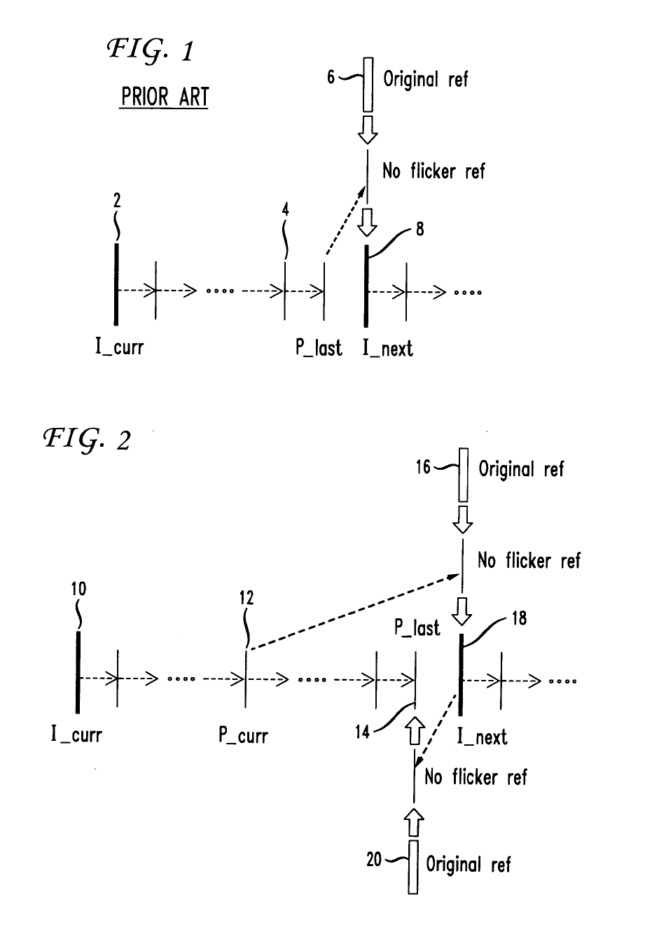

In the following description, the focus is on the coding of two consecutive GOPs in the same scene, and hence, deflicker for the 1st I-frame of the 2nd GOP. The 1st I-frame of the 1st and 2nd GOP as “I_curr” and “I_next”, respectively. We denote the last P-frame in the 1st GOP is denoted as “P_last”. Without loss of generality, it is assumed that the two GOPs are coded separately by two different encoding threads, and when one thread is about to start coding I_next, another thread only partially encodes the preceding GOP. The coded frame in the 1st GOP that has the highest display order is denoted as “P_curr”. Note that the frame of P_curr actually could be of any frame type other than I-frame. Herein, the use of P_curr is purely for notation convenience. Also note that P_curr is just the coded frame in the preceding GOP that is closest to I_next. These notations are as illustrated in FIG. 1 and FIG. 2.

Referring to FIG. 2, in the case of GOP-parallel multi-thread coding, as the two GOPs may be coded by two different encoding threads respectively, P_last 14 is most likely not coded yet, when coding I_next 18. Hence, I_next 18 deflicker has to resort to the closest coded preceding frame, i.e. P_curr 12. The challenge here is that: as P_curr 12 is further away from I_next 18 than P_last 14, it may be of much lower correlation with I_next 18. In that case, how to derive a good no flicker reference for I_next 18 from P_curr 12 is a more difficult task than deriving from P_last 14. In at least one implementation, a new simplified P-frame coding scheme to solve this problem is proposed. As explained in detail below, the proposed scheme bears many significant differences from previous simplified P-frame coding schemes, which are important for good multi-thread deflicker performance.

Besides new deflicker coding of I_next 18, the 2nd technique in our solution is the proposed deflicker coding of P_last 14. In multi-thread coding, it is highly likely that: when a thread is about to code the last frame in the current GOP, i.e. P_last 14, the first I-frame in the next GOP, i.e. I_next 18, has already been coded by another thread. In this case, we propose to conduct deflicker coding for P_last 14 as well. Note that in I_next 18 deflicker coding, a lot more bits are often allocated to the frame such that I_next 18 can be coded with small quantization parameters (QPs) and hence closely approach its no flicker reference. However, in the new P_last deflicker coding, closely approaching the no flicker reference is not desirable any more. This is because: although P_last 14 and I_next 18 may be highly correlated, P_curr 12 and P_last 14 might not be, and thus, temporal incoherence, i.e. flicker, artifacts may exist between the preceding frame of P_last 14 and I_next 18. Therefore, in this case, it is more preferable for P_last 14 to well balance between its coded preceding frame and the coded I_next 18 for the best overall deflicker performance, rather than closely approach the no flicker reference derived from either its coded preceding frame or the coded I_next 18. Therefore, in the proposed deflicker coding scheme of P_last 14, its no flicker reference is still derived from the coded I_next 18 via the same newly proposed simplified P-frame coding as in I_next deflicker coding. However, only a moderate amount of additional bits are further allocated to P_last 14. Thus, the resultant reconstructed P_last 14 represents a proper mixture of its preceding frame and I_next 18, which renders a more smooth transition between them.

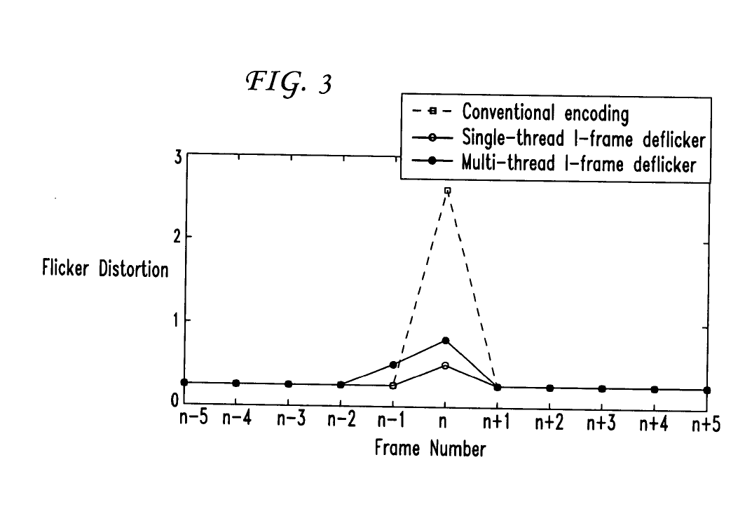

The overall proposed deflicker solution and the desired deflicker performance are illustrated in FIG. 2 and FIG. 3, respectively.

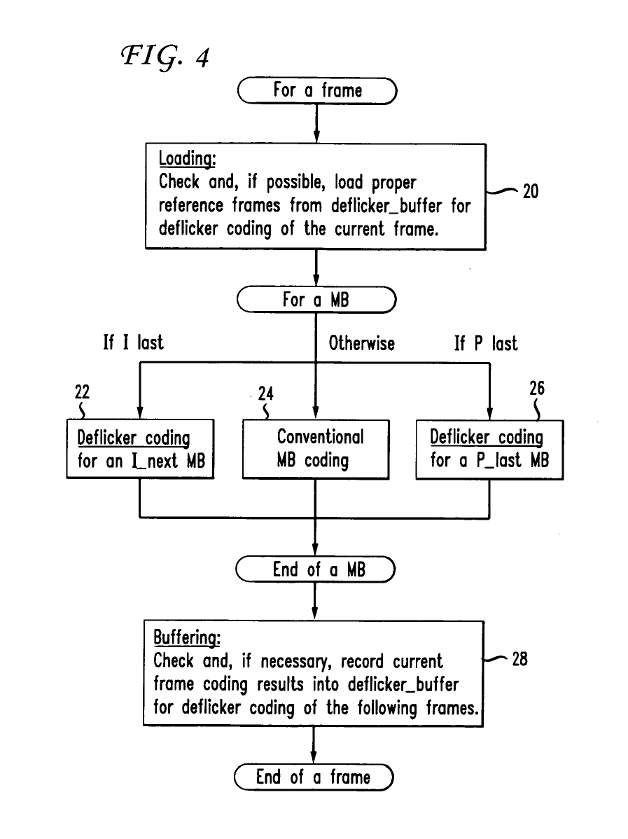

The implementation of the proposed deflicker scheme is explained in further detail in FIGS. 4˜8. FIG. 4 shows the overall flowchart of the proposed scheme for coding each frame. This depicts the proposed frame coding scheme to be conducted by all the encoding threads respectively. At step 20, when a thread is coding a frame, it first checks whether it is a qualified P_last 14 or I_next frame 18. If so, the thread will load proper reference frames from deflicker_buffer for deflicker coding of the frame.

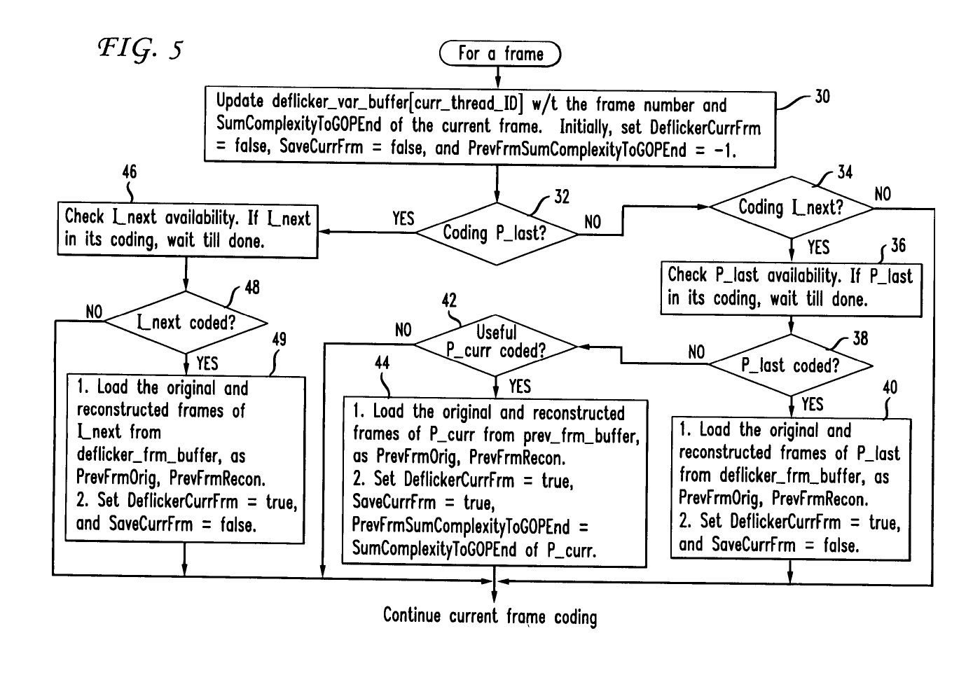

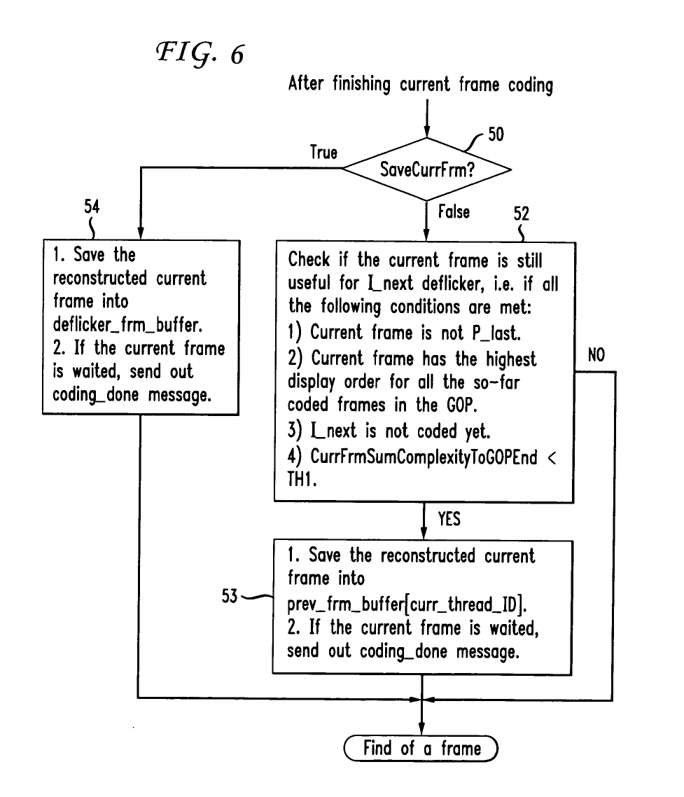

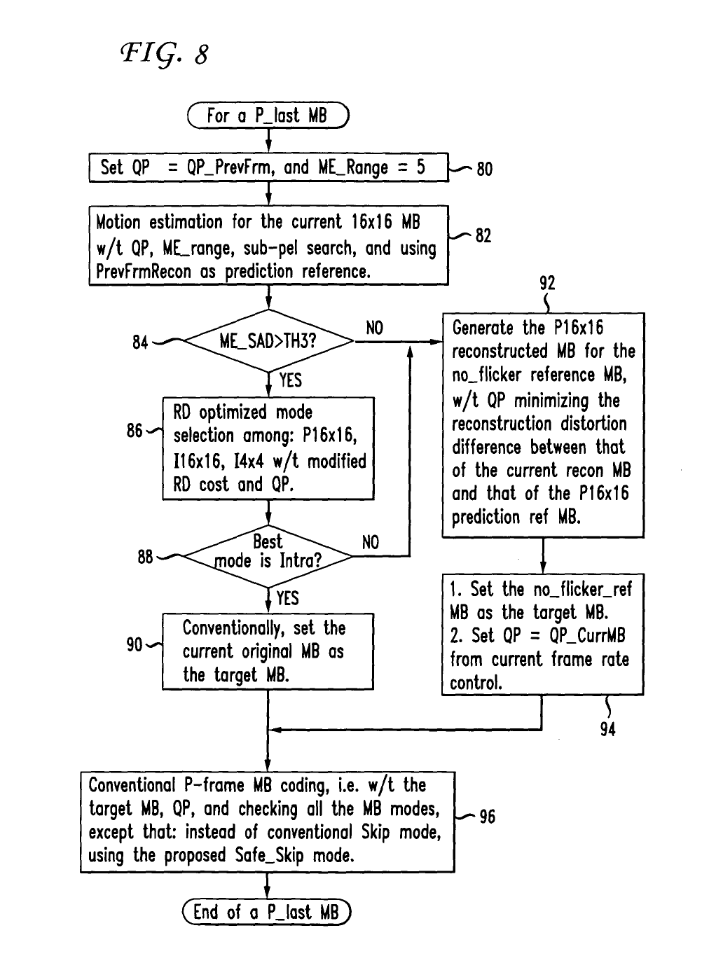

In the implementation, deflicker_buffer is an important and useful buffering mechanism that helps all the multiple threads buffer and share their coding results for I_next 18 or P_last 14 deflickering. In our current implementation, deflicker_buffer includes three parts:
1) deflicker_var_buffer: one for each encoding thread, indexed by a thread_ID, recording coding status variables of a thread, e.g. the current coding frame number (denoted by “CurrFrmNumber”), the accumulated frame coding complexity from the current frame to the end of the GOP (denoted by “SumComplexityFromCurrFrmToGOPEnd”), etc.
2) deflicker_form_buffer: one for all the threads, buffering latest P_last or I_next and their related other information for possible deflicker coding;
3) prev_frm_buffer: one for each encoding thread, buffering for each thread the coded frame that has the highest display order, and its related other information.
The usage of these buffers is explained in FIG. 4˜8. Note that for conciseness, the initializations of the buffers are not shown. In Step 24 the conventional MB coding process takes the original video frame as the target frame, and then chooses the best coding mode from all the MB coding mode options, i.e. including all the inter-frame and intra-frame prediction modes, usually based on the criterion of minimized rate-distortion (RD) cost. This is the so called RD optimized mode selection (RDO-MS). Then, the MB will be coded with the selected best coding mode into an output bitstream. Conventional coding of an MB is also explained in Step 78 and 96 for MBs in an I-frame and a P-frame, respectively. For Step 26, deflicker coding of a P_last MB is explained in detail in FIG. 8. Its reference frame buffer loading and updating are explained in Steps 42, 44, 46, 48, and 49 in FIG. 5, and FIG. 6, respectively. FIG. 6 provides the details of Step 28, where the involved variable of SaveCurrFrm is managed as shown in Steps 49, 44, and 40 in FIG. 5.

FIG. 5 explains the proper reference frame loading from deflicker_buffer. “curr_thread_ID” is the index identifying the current coding thread. At step 30, “SumComplexityToGOPEnd” is a quantity of each frame which is adopted to measure the correlation between the current frame and I_next. In the current implementation, the complexity between two consecutive frames is calculated as follows.

Cmp1= R̅ₘᵥ+ M̅A̅D̅ (1)

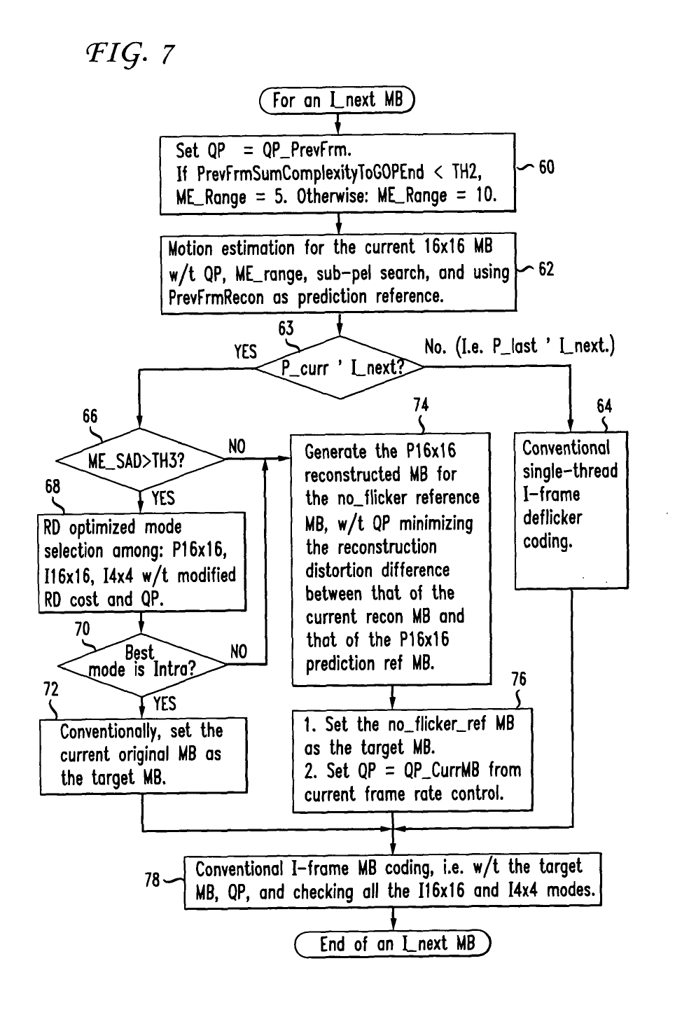

Herein, Cmp1 denotes the complexity of the latter frame. R̅ₘᵥ denotes the averaged MV coding bits over all the MBs in a frame, while M̅A̅D̅ denotes the averaged Luminance mean-absolute-difference (MAD) of the MB motion estimation error over all the MBs in a frame. Note that TH1 in FIG. 6 and TH2 in FIG. 7 are thresholds values related with a specific complexity metric. With the complexity metric in (1), TH1=250, TH2=20. One can see that higher complexity means lower correlation between frames.

FIG. 5 shows that when coding P_last 14, the process checks whether I_next 18 is coded already (Steps 32, 34) or not. If so, wait for P_Last coding to be completed at step 36 then load I_next 18 from deflicker_buffer (Step 40) for deflicker coding of P_last 14. Otherwise, P_last 14 will go through the conventional P-frame coding process at steps 42 and 44. When coding I_next, first check whether P_last is available or not at step 38. If so, load P_last for deflicker coding I_next (step 40). Otherwise, further check whether a useful P_curr is available at step 42. Herein a useful P_curr is defined as a P_curr frame with SumComplexityToGOPEnd<TH1, i.e. a P_curr that may be well correlated with I_next. If so, that P_curr will be loaded for I_next deflickering at step 44. In Step 46, due to multi-thread coding, while one thread is coding coding P_last in Step 46, I_next may be assigned to another thread, and either already coded, or not yet started coding, or in the middle of coding. Step 46 checks whether I_next is in the middle of coding. If so, the current coding thread will wait until the other thread finishes I_next coding. So, after Step 46, I_next is either already fully coded or not started coding yet. Step 48 will then check which case is true. If I_next is already coded, it will proceed with Step 49. Otherwise, it proceeds with Step 42. As explained in Step 49, when I_next is coded, one will exploit it to generate no-flicker reference for MB deflicker coding of the current P_last frame. The original and reconstructed previous frames are denoted as PrevFrmOrig, and PrevFrmRecon in FIG. 5. As for P_last MB coding, PrevFrmRecon is used in Step 82 in FIG. 8, and both of them are used in Step 92 for calculating the involved reconstruction distortion of the P16×16 prediction reference MB. DeflickerCurrFrm is a flag used in the current implementation, which indicates whether deflicker coding is used for the current frame coding. SaveCurrFrm is a flag checked in Step 50 of FIG. 6 for the updating of the deflicker_buffer.

FIG. 6 shows the deflicker_buffer updating with the current frame coding results.

At step 50, if SaveCurrFrm is true, an I_next 18 or a P_last 14 frame will be recorded in deflicker_frm_buffer for later on deflicker coding of P_last 14 or I_next 18, respectively at step 54. Otherwise, if the current coded frame is a so far most useful frame for I_next deflickering, the current frame results will be recorded into prev_form_buffer[curr_thread_ID] at steps 52, 53, which later on will be loaded as P_curr for I_next deflicker. Note that one needs to buffer the current frame results, only when all the four conditions in FIG. 6 are satisfied.

FIG. 7 shows the deflicker coding of an I_next MB. Herein, QP denotes the current MB coding QP. QP_PrevFrm denotes the MB average QP of the loaded reference frame. ME_range denotes the motion vector search range. Herein, ME_SAD denotes the Sum-of-Absolute-Difference of the prediction residue of the selected motion vector after motion estimation. TH3=10. This condition is to check whether a MB is with motion or is static at steps 60 and 62. QP_CurrMB denotes the current MB coding QP calculated from rate control. Note that in rate control, a lot more bits will be allocated to I_next to ensure its low QP coding so as to render the coded I_next closely approach its no flicker reference. In FIG. 7, if P_last is used at step 63 to generate no flicker reference of I_next for its deflicker coding, the deflicker coding would be expected to be the same as a GOP-sequential single-thread scheme as shown in steps 64 and 78. This case actually represents the best achievable deflicker performance of GOP-parallel multi-thread coding. Otherwise, P_curr, instead of P_last, will be used to generate no-flicker reference and used for deflicker coding of I_next, which is explained in Steps 66-76. FIG. 7 shows the details of at least one implementation of the newly proposed simplified P-frame coding, and this implementation involves many significant differences from a simplified P-frame coding scheme for single-thread encoding. These differences are summarized as follows:
1) Adaptive ME search range: if P_curr is of high correlation with I_next, use smaller search range (e.g. 5). Otherwise, use larger search range (e.g. 10).
2) No Skip mode checking in simplified RD optimized mode selection (RDO-MS)
3) Always use P16×16 mode with a quality matched QP to generate the no flicker reference, if the current MB is not a static MB or if an Inter-mode is selected via RDO-MS.
   Besides these differences, I_next deflicker coding via P_curr in Step 66-76 follow almost the same scheme as in conventional single-thread I-frame deflicker coding. Briefly, if a MB's ME_SAD is larger than a threshold, and the best RD optimal mode is an Intra-prediction mode, then the MB is identified as a high motion, and hence, flicker insensitive, MB, for which deflicker coding is not necessary, and hence, it will coded in conventional way of taking the original MB as the target MB as shown in Step 90. Otherwise, the MB is identified as a low motion, and hence flicker prone, MB, which will be coded for deflickering. In that case, a no-flicker reference MB will be first generated as shown in Step 92, which will then be taken as the target MB for the current MB coding.

FIG. 8 shows the deflicker coding of a P_last MB. The differences with deflicker coding of a I_next MB as in FIG. 7 are:
1) As P_last immediately precedes I_next, highly correlated areas between them have to be of low motion so as to be flicker prone. Hence, smaller ME search range set at step 80 is adequate. Similarly as with Steps 66-76, Steps 84-90 follow almost the same scheme as in conventional single-thread I-frame deflicker coding.
2) QP_CurrMB from rate control for a P_last MB deflickering bears medium values as shown in steps 92 and 94. Because as discussed earlier, medium coding quality of P_last is preferred so as to render its reconstruction a proper balance or mixture between the coded I_next and its coded preceding frame.
3) In the 2″ pass of actual coding, no Skip mode is used. Instead, Safe_Skip mode will be used at step 96. Safe_Skip mode is actually an alternative P16×16 mode with the MV the same as of the Skip mode, i.e. incurring no MV coding bits. Note that in this mode, prediction residue will be coded so as to prevent un-expected bad quality of Skip mode coding. Skip mode is a standardized MB coding mode in most of recent video coding standards, e.g. H.264/AVC, which states that a MB will be coded using Inter-frame prediction, however, it will simply use the exact motion vector predicted from motion vectors of the neighboring coded MBs from motion compensation, and exclude the coding of the prediction residue. Hence, it represents the least bit consuming MB coding mode, however, more often than not, the mode with largest coding distortion among all the coding modes. Safe Skip mode is our proposed new alternative mode for Skip mode, which use the same motion vector as that of Skip mode, however, it encodes the prediction residue as in a P16×16 mode. Therefore, comparing to other Inter-prediction modes, e.g. P16×8, 8×16, 8×8, 8×4, 4×8, 4×4, etc., it spends no bits on motion vector coding, while yielding similar coding distortion due to the involved residue coding.

Also, note that simplified RDO-MS in P_last or I_next MB no flicker generation both involve modified RD cost for each candidate mode, which is also critical for the ultimate remarkable and reliable deflicker performance. Basically, via modifying the RD cost in RDO-MS, Skip and Intra modes are more discouraged, while Inter-prediction modes are more favorable. This proves to be an effective means for better deflicker performance. Specifically, in no flicker reference generation, RD costs of Inter modes are multiplied by 0.7 for increased preference and for P_last MBs, in both no flicker reference generation and actual coding, RD costs of Intra modes are multiplied by 2.5 for reduced preference.

Last but not least, as mentioned earlier, rate control has to coordinate with deflicker coding of I_next 18 and P_last 14 well. Basically, in frame-level rate control, a lot more bits need to be allocated for I_next deflickering, while a moderate amount of more bits need to be allocated for P_last deflickering. This usually can be achieved by assigning proper QP offsets for a frame when conducting frame-level bit allocation. In our current implementation, we assign −6 and −2 for I_next and P_last QP offsets respectively.

Experiments have been done to evaluate the performance of the above proposed GOP-parallel multi-thread deflicker solution. Results show that the proposed scheme is able to effectively reduce I-frame flickering artifacts in the multi-thread coding case, while the incurred additional computational complexity does not pose a serious challenge for the accomplishment of real-time coding. Especially, we found that shorter GOP lengths (e.g. <60) are more desirable for better deflicker performance than larger GOP lengths (e.g. >90), as with shorter GOP lengths, the distance between P_curr 12 and I_next 18 will more likely to be short as well, which is highly favorable for good deflickering.

Herein, provided are one or more implementations having particular features and aspects. However, features and aspects of described implementations may also be adapted for other implementations. For example, implementations may be performed using one, two, or more passes, even if described herein with reference to particular number of passes. Additionally, the QP may vary for a given picture or frame, such as, for example, varying based on the characteristics of the MB. Although implementations described herein may be described in a particular context, such descriptions should in no way be taken as limiting the features and concepts to such implementations or contexts.

The implementations described herein may be implemented in, for example, a method or process, an apparatus, or a software program. Even if only discussed in the context of a single form of implementation (for example, discussed only as a method), the implementation or features discussed may also be implemented in other forms (for example, an apparatus or program). An apparatus may be implemented in, for example, appropriate hardware, software, and firmware. The methods may be implemented in, for example, an apparatus such as, for example, a computer or other processing device. Additionally, the methods may be implemented by instructions being performed by a processing device or other apparatus, and such instructions may be stored on a computer readable medium such as, for example, a CD, or other computer readable storage device, or an integrated circuit. Further, a computer readable medium may store the data values produced by an implementation.

As should be evident to one of skill in the art, implementations may also produce a signal formatted to carry information that may be, for example, stored or transmitted. The information may include, for example, instructions for performing a method, or data produced by one of the described implementations.

Additionally, many implementations may be implemented in one or more of an encoder, a pre-processor for an encoder, a decoder, or a post-processor for a decoder.

Further, other implementations are contemplated by this disclosure. For example, additional implementations may be created by combining, deleting, modifying, or supplementing various features of the disclosed implementations.

The following list provides a short list of various implementations. The list is not intended to be exhaustive but merely to provide a short description of a small number of the many possible implementations as follows:
1. A video encoder with multiple encoding threads for GOP-parallel real-time coding, that reduces I-frame flickering by first deflicker coding the I-frame with derived no flicker reference from the closest coded frame in the preceding GOP, and then, deflicker coding the last P-frame in the preceding GOP with derived no flicker reference from the deflicker coded I-frame.
2. Implementation 1 where small QPs are used in actual coding of the 1^{st} I-frame to closely approach its no-flicker reference, and medium QPs are used in actual coding of the last P-frame to render the coded frame a balanced mixture of the coded I-frame in the next GOP and the coded preceding frame in the current GOP.
3. Implementation 1 where no-flicker reference is generated via one pass of simplified P-frame coding in deflicker coding of a frame.
4. Implementation 3 where the simplified P-frame coding involves: (i) larger motion search range for lower correlation between the current I-frame and the closest coded frame in the preceding GOP, and vice versa, (ii) no Skip mode checking in mode selection, (iii) modified RD cost in RDO-MS discouraging Skip and Intra modes.
5. Implementation 1 where sum inter-frame complexity is used to determine the correlation level between the current I-frame and the coded closest frame in the preceding GOP.
6. Implementation 1 where for deflicker coding of the last P-frame in a GOP, Safe_Skip as defined in one or more implementations of this disclosure is used, instead of the conventional Skip mode, in the actual MB coding.
7. Implementation 1 where a multi-thread buffering and communication mechanism as defined in one or more implementations of this disclosure is adopted, that separately buffers the reconstructed coded frame with the highest display order in a GOP for each encoding thread, and the reconstructed last P-frame or first I-frame of a GOP for all the threads.
8. A signal produced from any of the described implementations.
9. Creating, assembling, storing, transmitting, receiving, and/or processing video coding information for an I-frame or a P-frame according to one or more implementations described in this disclosure in order to reduce flicker.
10. A device (such as, for example, an encoder, a decoder, a pre-processor, or a post-processor) capable of operating according to, or in communication with, one of the described implementations.
11. A device (for example, a computer readable medium) for storing one or encodings of an I-frame or a P-frame, or a set of instructions for performing an encoding of an I-frame or a P-frame, according to one or more of the implementations described in this disclosure.
12. A signal formatted to include information relating to an encoding of an I-frame or a P-frame according to one or more of the implementations described in this disclosure.
13. Implementation 12, where the signal represents digital information.
14. Implementation 12, where the signal is an electromagnetic wave.
15. Implementation 12, where the signal is a baseband signal.
16. Implementation 12, where the information includes one or more of residue data, motion vector data, and reference indicator data.
17. A process, or a device or set of instructions for implementing a process, that reduces flicker for a multi-threaded encoding of video.

The embodiments described present an effective I-frame deflicker scheme for GOP-parallel multi-thread video encoding. The proposed scheme can reduce the impact of the unavailability of the reconstructed immediate previous frame on the current I-frame deflickering. The scheme is also efficient, as it incurs marginal additional computation and memory cost, and thus, fits very well in a real-time video coding system.

In sum, presented herein is a means of properly changing an encoder and its method of encoding in a more direct and general way to solve the various artifact removal problems discussed above.

While some schemes address the deflicker problem for all Intra-frame coded video, either with the Motion JPEG2000 standard, or with the H.264/AVC standard, at least one implementation in this disclosure provides a deflicker solution that is compatible with the main-stream video coding standards, i.e. the well-know hybrid coding paradigm with motion compensation and transform coding. Moreover, this application is concerned with GOP coded video, where each GOP starts with an I-frame.

1. A method of encoding video comprising the steps of:
forming multiple groups of pictures (GOPs);
beginning multiple encoding of parallel threads of GOPs, each having an initial I-frame followed by a series of P-frames;
deflicker coding each I-frame with a first derived no flicker reference from the nearest coded frame of a preceding GOP; and,
deflicker coding the last P-frame in the series of the preceding GOP with a second derived no flicker reference from the deflicker coded I-frame.

2. The method of claim 1 wherein small quantization parameters (QPs) are employed in coding the I-frame to closely approach the first no flicker reference.

3. The method of claim 3 wherein medium QPs are employed in coding the last P-frame.

4. The method of claim 1 wherein the first derived no flicker reference is generated by a one pass simplified P-frame coding.

5. The method of claim 4 wherein the simplified p-frame coding comprises the step of applying a larger motion search range for a low correlation between the I-frame and the nearest coded frame in the preceding GOP.

6. The method of claim 4 wherein the simplified p-frame coding comprises the step of applying a smaller motion search range for a high correlation between the I-frame and the nearest coded frame in the preceding GOP.

7. The method of claim 4 wherein the simplified p-frame coding comprises forgoing skip mode checking in mode selection.

8. The method of claim 4 wherein the simplified p-frame coding comprises the step of checking only P16×16 mode, using smaller motion search range, and coding distortion matching between the current frame MB and the prediction reference MB, and modifying RD cost in RDO-MS, thereby preventing or discouraging skip and intra modes.

9. The method of claim 5 wherein the correlation is determined by sum inter-frame complexity.

10. The method of claim 6 wherein the correlation is determined by sum inter-frame complexity.
